(19) United States
(12) Patent Application Publication
(10) Pub. No.: US 2007/0187452 A1
(43) Pub. Date: Aug. 16, 2007

(54) Tool bit for driving an elongated fastener

(76) Inventor: Brian E. Budzisz, Palatine, IL (US)

Correspondence Address: WALLENSTEIN & WAGNER, LTD., 311 SOUTH WACKER DRIVE, 53RD FLOOR, CHICAGO, IL, 60606, US

(21) Appl. No.: 11/356,587

(22) Filed: Feb. 16, 2006

(51) Int. Cl. B25C 7/00

(52) U.S. Cl. 227/147

(57) ABSTRACT

The invention provides a heat treated, one-piece bit for driving an elongated fastener. The bit comprises a barrel having a bore extending inward from an end wall of the barrel. The bore defines an internal receiver that receives an extent of the fastener. A shank extends from the barrel and has a collar that ensures proper positioning of the bit when inserted in a pneumatic tool. A conical transition segment is positioned between the barrel and the shank. The bit can include a first receiver that receives a first sized fastener and a second receiver that engages a second sized fastener to provide the bit with greater utility. The first receiver extends inward from an end wall of the bit, and the second receiver extends deeper into the bit from the first receiver.

### TECHNICAL FIELD

The invention relates to a tool bit for use in driving an elongated fastener such as an elongated pin, rivet, stake or spike. More specifically, the bit is inserted into a pneumatic tool and has an internal receiver that receives an extent of the fastener for driving of the fastener into a surface.

### BACKGROUND OF THE INVENTION

There currently exists a number of pneumatic tool bits including simple chisels, cutters and hammer bits, wherein the hammer bit includes a bulbous protrusion. No existing pneumatic tool bit is designed to receive and then drive elongated fasteners. Similarly, there are post driver assemblies. However, these assemblies include many interacting parts and the driver assemblies are quite large and not intended for use with a pneumatic tool.

One example of a post driver assembly is disclosed in U.S. Pat. No. 2,525,316 to Schiff. There, the post driver assembly includes an elongated hollow track member with two hammer elements connected by an external sleeve, wherein the hammer elements and the sleeve vertically slide along an outer surface of the track. A post is inserted within the track and has an opening that receives a drive pin. The drive pin is connected to a lower anvil that engages the hammer elements when they are driven downward into contact with the anvil. Thus, the operator reciprocates the hammer elements and the sleeve into the anvil to drive the post via the drive pin. Due to the positioning of the post opening that receives the pin, the pin must be removed from the post and reinserted into an upper portion of the post to further drive the post into the ground. Due to the many moving components that necessitate pin removal and repositioning, the driver assembly is inefficient in use. Other existing post drivers are large, multi-component assemblies that cannot be used with a pneumatic tool, such as a pneumatic hammer, and have short operational life due to the significant wear caused by the moving components.

The present invention is provided to solve the problems discussed above and other problems, and to provide advantages and aspects not provided by prior tool bits. A full discussion of the features and advantages of the present invention is deferred to the following detailed description, which proceeds with reference to the accompanying drawings.

### SUMMARY OF THE INVENTION

The present invention is directed to a one-piece bit that comprises a barrel and a shank extending therefrom, wherein an extent of the shank is inserted into a tool used to drive a fastener with the bit. The barrel has an internal receiver that receives an extent of the fastener. In addition to the receiver, the barrel has a solid core extending from an interior end wall of the receiver to a second end of the barrel. The barrel also includes a ring portion that represents the solid portion of the barrel positioned between the receiver and an outer wall of the barrel and generally below the core. The shank also includes a collar that extends outward from the shank. When the shank is inserted into the tool, the collar engages an outer surface of the tool to ensure proper positioning of the bit for use.

According to another aspect of the invention, the bit includes a barrel with a first receiver and a second receiver, wherein the first receiver has a first diameter and the second receiver has a second diameter, wherein the former exceeds the latter. The first receiver receives an extent of a first-sized fastener, and the second receiver receives an extent of a second-sized fastener. In a use position, the second fastener extends through the first receiver and into the second receiver. A shoulder is formed between the first and second receivers wherein the shoulder prevents the first fastener from entering the second receiver. The two receivers provide the bit with greater utility since different sized fasteners can be accepted and driven by the same bit.

According to another aspect of the invention, the bit includes a first receiver with mean for releasably retaining the fastener in order to prevent unintended release of the fastener from the receiver. The inner wall has a channel that houses the retaining means. The retaining means can be a detent assembly with a ball bearing biased radially inward by a spring. Alternatively, the retaining means is a deformable elastomeric member, such as a rubber or nylon washer or ring, that resides in the channel of the inner side wall. In use, the retaining means is configured to overcome the effects of gravity and prevent unintended release of the fastener from the receiver.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a perspective view of the tool bit of the invention, showing the bit disengaged from a fastener;

FIG. 2 is a side view of the bit, showing an internal receiver;

FIG. 3 is a bottom end view of the bit;

FIG. 4 is a cross-section of the bit taken along line 4-4 of FIG. 3;

FIG. 5A is a cross-section of the bit, showing the bit connected to a tool and engaged with the fastener in a first position to drive the fastener through a substrate into the ground;

FIG. 5B is a cross section of the bit, showing the bit connected to a tool and engaged with the fastener in a second position wherein the fastener is driven through the substrate and into the ground;

FIG. 6 is a partial cross-section of an alternate bit, showing two internal receivers;

FIG. 7 is a partial cross-section of the alternate bit of FIG. 6, showing a first receiver engaging a first-sized fastener;

FIG. 8 is a partial cross-section of the alternate bit of FIG. 6, showing a second receiver engaging a second-sized fastener;

FIG. 9 is a partial cross-section of an alternate bit, the receiver having a fastener retaining means to releasably secure the fastener; and,

FIG. 10 is a partial cross-section of an alternate bit, the receiver having another fastener retaining means to releasably secure the fastener.

### DETAILED DESCRIPTION

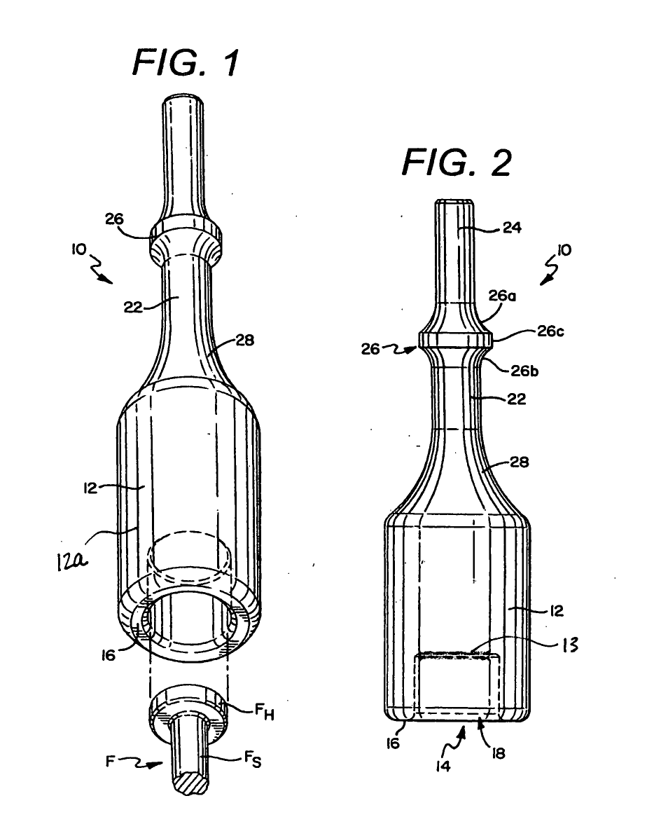

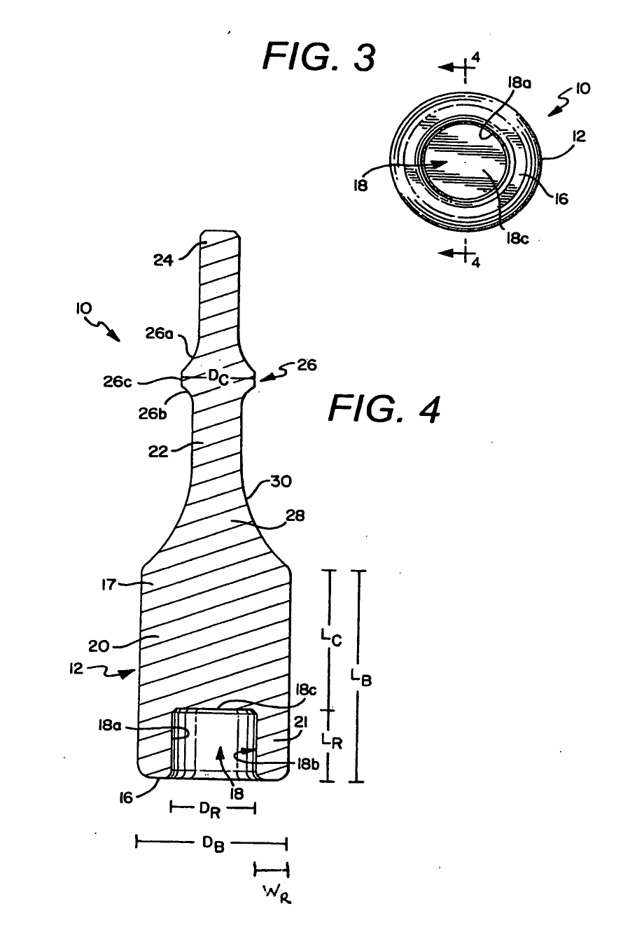

FIGS. 1-5 provide a unitary or one-piece bit 10 of the present invention. The bit 10 comprises a barrel 12 and a shank 22 extending therefrom, wherein an extent of the shank 22 is inserted into a tool used to drive an elongated fastener F with the bit 10. The fastener F can be a pin, rivet, nail, spike, stake or elongated fastener to join or secure a plurality of structures. The barrel 12 has a bore 14 extending inward from a first end wall or bottom wall 16 of the barrel 12. The bore 14 defines an internal receiver 18 that receives an upper extent of the fastener F, namely the fastener head F_{H}. The receiver 18 has an inner wall 18a and a cylindrical sidewall arrangement 18b, wherein the receiver 18 is cooperatively dimensioned to receive the fastener head F_{H} and an extent of the fastener shaft F_{S}. Therefore, the diameter of the receiver 18 slightly exceeds the diameter of the fastener head F_{H}. As shown in FIG. 4, the receiver 18 has a length L_{R} that is less than the length L_{B} of the barrel 12. Although the receiver 18 is shown having a generally cylindrical configuration, the receiver 18 configuration varies with the type of fastener F to be driven. For example, the fastener F can have a hexagonal head F_{H} wherein the receiver 18 has a corresponding hexagonal sidewall arrangement 18b resulting from five inner wall segments 18a. In this configuration, the engagement between hexagonal head F_{H} and the sidewall arrangement 18b can prevent rotation of the fastener F when it is driven by the bit 10. As another example, the fastener head F_{H} can have a raised segment or projection that is engaged by a recess in the inner wall 18a when the fastener F is inserted into the receiver 18. Similarly, the engagement between raised segment of the head F_{H} and the inner wall 18a can prevent rotation of the fastener F while it is being driven.

In addition to the receiver 18, the barrel 12 has a solid core 20 extending from an interior end wall 18c of the receiver 18 to a second end 17 of the barrel 12. Preferably, the length L_{C} of the core 20 exceeds the receiver length L_{R} to provide the core 20 with a substantial mass that imparts a driving force upon the fastener F during use of the bit 10. The barrel 12 also includes a ring portion 21 defined as the solid portion of the barrel 12 positioned between the receiver 18 and an outer wall 12a of the barrel 12, and generally below the core 20. The ring 21 has a width that varies with the dimensions of the receiver 18 and the barrel 12; however, the ring 21 dimensions should not be minimized to the point where the barrel 20 integrity is compromised.

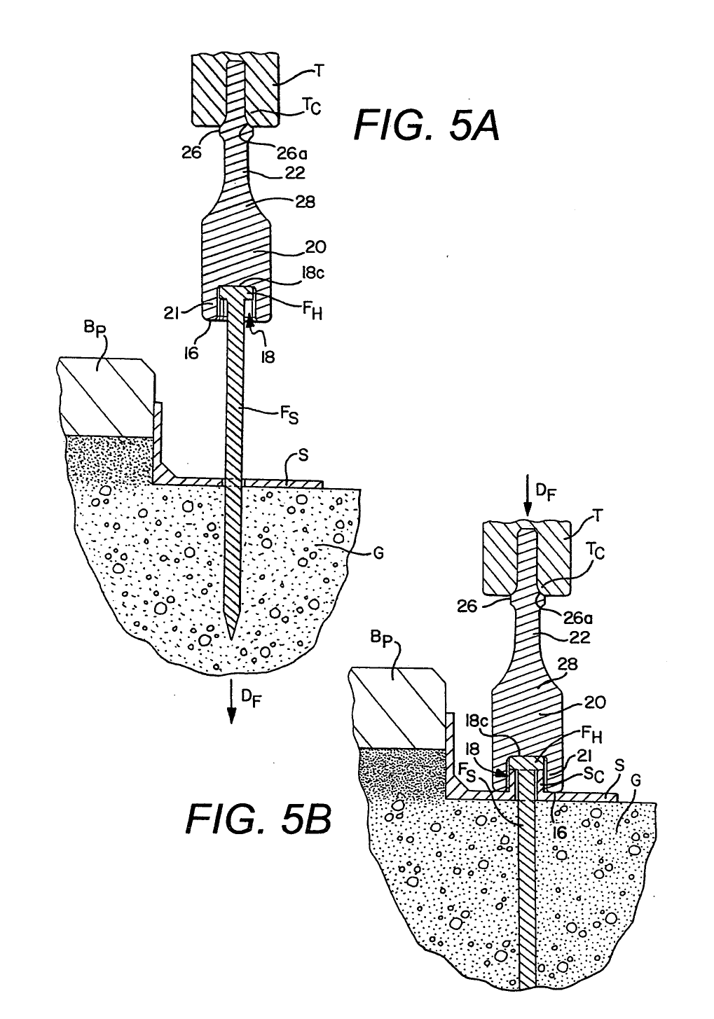

The bit 10 further comprises an integral shank 22 extending from the barrel 14. The shank 22 has an upper or terminal end 24 that is inserted into the chuck T_{C} or opening of the pneumatic tool T (see FIG. 5). The shank 22 also includes a collar 26 that extends outward from the shank 22. Preferably, the collar 26 includes an upper wall 26a, an outer wall 26b, and a lower wall 26c. In the embodiment shown in FIGS. 1-5, the upper and lower walls 26a, c have a curvilinear configuration that define a transition segment between the outer wall 26b and the shank 22. Alternatively, the upper and lower walls 26a, c extend perpendicularly from the shank 22 thereby eliminating the curvilinear configuration shown in FIG. 4. When the terminal shank end 24 is inserted into the tool T, the upper collar wall 26a engages an outer surface of the tool T to ensure proper positioning of the bit 10 for use (see FIG. 5). In one embodiment, the collar 26 has a circumference that exceeds the circumference of the shank 22 but is less than the circumference of the barrel 12. Described in a different manner, the collar 26 has a diameter D_{C} that is similar to the width or diameter D_{R} of the receiver 18, but less than the diameter D_{B} of the barrel 12. In another embodiment where a smaller fastener F is intended to be driven by the bit 10, the collar 26 has a circumference that corresponds to the circumference of the barrel 12. To maintain the balance of the bit 10 during operation, the collar 26 is preferably positioned at least 1.0 inch from the terminal end 24.

The bit 10 also comprises a transitional neck segment 28 positioned between the barrel 12 and the shank 22. As shown in FIGS. 1, 2 and 4, the neck segment 28 has a frustoconical configuration with curvilinear side wall portions 30. In another embodiment, the neck segment 28 has notched or angular exterior walls 30. In yet another embodiment, the curvilinear neck segment 28 is omitted whereby the shank 22 directly extends from the second end 17 of the barrel 12 and there is a notched configuration between the shank 22 and the barrel 12.

As seen from the Figures, the bit 10 is symmetrical about a longitudinal axis that extends through the barrel 12, the receiver 18 and the shank 22. The bit 10 is machined from a solid metal blank, such as a low alloy or high alloy steel blank. If the blank is a low alloy variety, it can be of the low carbon, medium carbon or high carbon classification. Preferably, the bit 10 is formed from high-carbon steel with a tensile strength ranging from 800 to 1300 MPa (megapascal) and a yield strength ranging from 500-950 MPa. Alternatively, the bit 10 is formed from medium carbon steel stock. Preferably, the bit 10 is heat treated or annealed to increase its strength and life. The heat treatment can include a heating step followed by a cooling step, wherein the bit 10 is heated to an elevated temperature for an extended period of time and then slowly cooled to ambient. Alternatively, the cooling step can further involve quenching of the bit 10 in a liquid, such as water or oil. Due to the heat treating, the bit 10 has a hardness depth of approximately 1/16 of an inch and a Rockwell hardness classification of 52-57 R/C, with 54-55 R/C being preferred.

FIGS. 5A and B, show the operation of the bit 10 to drive the fastener F from a first position (FIG. 5A) to a second position (FIG. 5B), whereby the fastener F is driven through a substrate S and into the ground G. The substrate S can be edging or framing used to stabilize landscaping stones or brace brick pavers BP, as commonly found in driveways, patios, and walkways. The substrate S of FIG. 5B includes a vertical collar S_{C} that surrounds the opening through which the fastener F is driven by the bit 10.

To commence use, the operator inserts the shank 22 into the chuck T_{C} or outward opening in the tool T. The tool may be a pneumatic air hammer that supplies the driving force that is transferred to the bit 10. The upper wall 26a of the collar 26 engages the tool T to properly position the bit 10 within the tool T and then the chuck T_{C} is tightened. Next, the operator inserts the fastener F into an opening in the substrate S to maintain the fastener F in a substantially vertical position to define a preliminary driving position, wherein the fastener F is ready for driving through the substrate S and into the ground G. The tool T and the bit 10 are then brought into engagement with the fastener F, wherein the fastener F is inserted into the bit 10 such that the fastener head F_{H} engages the upper end wall 18a of the receiver 18 and an extent of the fastener shaft F_{S} resides within the receiver 18. In one embodiment of the bit 10, the receiver 18 is configured to receive at least 0.75 inch of the fastener F, which includes the fastener head F_{H} and a portion of the fastener shaft F_{S}.

Alternatively, the operator inserts the fastener F into the receiver 18 while the bit 10 is secured within the chuck T_{C}, and then manually inserts the fastener F into the substrate S thereby placing the fastener F, the tool T and the bit 10 in the preliminary driving position. Once the preliminary driving position is reached, the tool T is activated to impart a driving force DF through the bit 10 and to the fastener F to drive it through the substrate S and into the ground G. As shown in FIG. 5A, the driving force DF is downwardly directed from the tool T and is substantially perpendicular to the ground G. Through the reception of the fastener head F_{H} and an extent of the fastener shaft F_{S} in the receiver 18, the bit 10 secures the fastener F substantially perpendicular to the ground G such that the driving force DF can be applied to the fastener head F_{H}. As shown in FIG. 5B, the tool T and the bit 10 continue to apply the driving force DF until the fastener F is fully received by the ground G and the fastener head F_{H} is adjacent an upper surface of the substrate collar S_{C}. To ensure the complete driving of the fastener F, the receiver length L_{R} should not exceed the combination of the height of the substrate collar S_{C} and the height of the fastener head F_{H}. Furthermore, the receiver diameter DR should be large enough to enable the receiver 18 to accept both the fastener head F_{H} and the diameter of the substrate collar S_{C}. In a preferred embodiment shown in FIG. 5B, the bit 10, including the receiver 18, is dimensioned such that the end wall 16 of the barrel 12 engages an upper surface of the substrate S.

Once the fastener F is fully driven, the second position of FIG. 5B, the bit 10 is disengaged from the fastener F and can be used to drive other fasteners F through the substrate S and the ground G. Instead of the substrate collar S_{C}, the substrate S can include a recess to receive the barrel ring 21 such that the fastener head F_{H} is substantially flush with an upper surface of the substrate S. The driving force DF is aligned with the longitudinal axis of the bit 10, wherein the axis remains substantially perpendicular to the ground G when the fastener F is driven.

In order to impart a sufficient driving force DF on the fastener F, one component of the bit 10 must be properly sized relative to other components. For example and as shown in FIG. 4, the barrel length L_{B} exceeds both the receiver length L_{R} and the core length L_{C}. However, the core length L_{C} exceeds the receiver length L_{R}. As another example, the barrel diameter D_{B} exceeds both the receiver diameter D_{R} and the collar diameter D_{C}. However, the receiver diameter D_{R} slightly exceeds the collar diameter D_{C}. While the receiver diameter D_{R} exceeds the width W_{R} of the ring 21 (which corresponds to the thickness of the end wall 16), the width of the ring 21 should not be diminished such that the structural integrity of the barrel 12 is compromised from repeated use of the bit 10. The geometry of the bit 10 is further characterized by the dimensional ratios of the various components. In one embodiment, the ratio of the receiver length L_{R} to the core length L_{C} is at least 1:1.75 and the ratio of the receiver length L_{R} to the barrel length L_{B} is at least 1:2.75. The ratio of the inner diameter, represented by the receiver diameter D_{R}, to the outer diameter, represented by the barrel diameter D_{B}, is at least 1:1.5. These dimensions provide a sufficiently sized barrel 12 and core 20 to impart the driving force DF upon the fastener F. In one preferred embodiment, the receiver length L_{R} is approximately 0.750 inch, the core length L_{C} is approximately 1.50 inches, the barrel length L_{B} is approximately 2.25 inches, and the length of the shank 22 is approximately 3.50 inches.

As explained in the previous paragraph, the dimensions of the bit 10 are optimized to provide the driving force DF. Accordingly, the weight of the bit 10, including the components, is optimized. In one embodiment, the solid core 20 has a mass of at least 10 ounces (570 grams) to provide the driving force DF to the fastener F compared to an overall weight at least 20 ounces (85 grams) for the bit 10. Also, the ring 21 has a mass of at least 3 ounces (85 grams) and the shank 22, including the collar 26, has a mass of at least 5 ounces (140 grams). As a result, the ratio of the core 20 mass to the bit 10 mass is 1:2, and the ratio of the barrel 12 (core 20 and ring 21 combined) mass to the bit 10 mass is 1:1.54. In a preferred embodiment, the core 20 has a mass of approximately 12 ounces and the bit 10 has a mass of 21 ounces. As a result, the ratio of the core 20 mass to the bit 10 mass is 1:1.75.

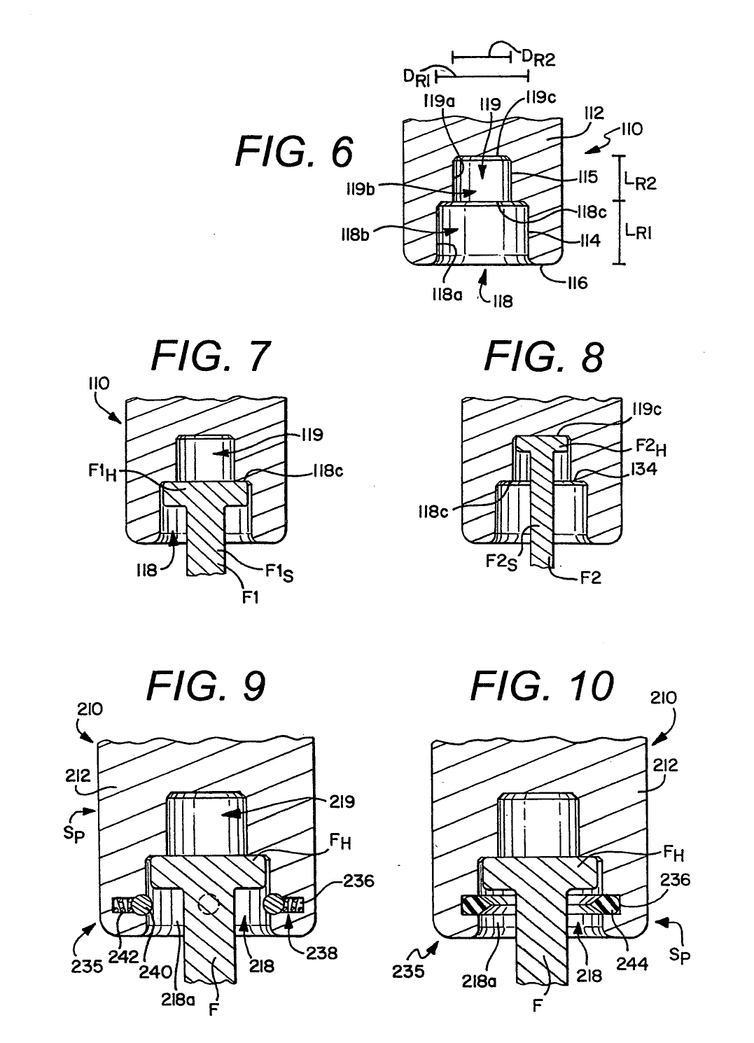

In the embodiment of FIGS. 6-8, the unitary bit 110 includes a barrel 112 with a first bore 114 that defines a first receiver 118, and a second bore 115 that defines a second receiver 119. The first receiver 118 extends inward from a bottom wall 116 of the barrel 112 and the second receiver 119 extends inward from the interior end wall 118c of the first receiver 118. The first receiver 118 has a first diameter D_{R1} and the second receiver 119 has a second diameter D_{R2}, wherein the former exceeds the latter. Referring to FIGS. 7 and 8, the first receiver 118 receives an extent of a first-sized fastener F1, and the second receiver 119 receives an extent of a second-sized fastener F2. The first receiver 118 has an inner wall 118a and a cylindrical sidewall arrangement 118b wherein the receiver 118 is cooperatively dimensioned to receive the first fastener head F1_{H} and an extent of the fastener shaft F1_{S}. Depending upon its design, all or a portion of the first fastener head F1_{H} engages the interior end wall 118c during use of the bit 110. The second receiver 119 has an inner wall 119a and a cylindrical sidewall arrangement 119b wherein the receiver 119 is cooperatively dimensioned to receive the second fastener head F2_{H} and an extent of the fastener shaft F2_{S}. In a use position, the second fastener F2 extends through the first receiver 118 and into the second receiver 119. Depending upon its design, all or a portion of the second fastener head F2_{H} engages the interior end wall 119c during use of the bit 110. A notch or shoulder 134 is formed between the first and second receivers 118, 119 wherein the shoulder 134 prevents the first fastener F1 from entering the second receiver 119. The two receivers 118, 119 provide the bit 110 with greater utility since different sized fasteners can be accepted and driven by the same bit 110.

Although FIGS. 6-8 show both receivers 118, 119 as having a generally cylindrical configuration, either receiver 118, 119 configuration can vary with the type of fasteners F1, F2 to be driven by the bit 110. For example, the first fastener F1 can have a hexagonal head F1_{H} wherein the receiver 118 has a corresponding hexagonal sidewall arrangement 118b, and the second fastener F2 can have a triangular head F2_{H} wherein the receiver 119 has a corresponding triangular sidewall arrangement 119b. Similarly, the engagement between the raised segment of the head F_{H} and the inner wall 18a can prevent rotation of the fastener F in use. Although FIG. 6 shows the first receiver 118 to have a length L_{R1} that exceeds the length L_{R2} of the second receiver 119, the length L_{R2} can be increased to match or exceed the length L_{R1}. Collectively, the lengths L_{R1}, L_{R2} of the first and second receivers 118, 119 may exceed a midpoint of the barrel 120.

In another embodiment shown in FIGS. 9 and 10, the bit 210 includes a first receiver 218 with means 235 for releasably retaining the fastener F in order to prevent unintended release of the fastener from the receiver 218. The inner wall 218a includes a channel 236 that houses the retaining means 235. Although the retaining means 235 is shown only in the first receiver 218, the retaining means 235 can be located in both receivers 218, 219. Similarly, the receiver 18 of the bit 10 shown in FIGS. 1-5 can include a retaining means 235. Referring to FIG. 9, the retaining means 235 can be a detent assembly 238 with a ball bearing 240 biased radially inward by a spring 242. Although two distinct detent assemblies 238 are shown in FIG. 9 (with another denoted in broken lines), the retaining means 235 can extend along all or a substantial extent of the inner wall 218a. Referring to FIG. 10, the retaining means 235 is a deformable elastomeric member 244, such as a rubber or nylon washer or ring, that resides in the channel 236 of the inner side wall 218a. Although the elastomeric member 244 is shown as a continuous washer, the retaining means 235 can comprise a plurality of elastomeric fingers that extend radially inward from the side wall 218a. Alternatively, the retaining means 235 is a magnet that is secured to an interior end wall of the receiver 18, 118, 119, 218.

In use, the retaining means 235 is configured to overcome the effects of gravity and prevent unintended release of the fastener F from the receiver 218. The fastener F is inserted into the receiver 218 such that the fastener head F_{H} extends past the retaining means 235 and makes contact with the interior end wall 118c to define a secured position SP (see FIGS. 9 and 10). In the secured position SP, the fastener head F_{H} is positioned between the retaining means 235 and the interior end wall 118, wherein the retaining means 235 prevents release of the fastener F until the operator applies an upwardly directed force that is significant enough to overcome the retaining means 235. Typically, the fastener F is driven into the substrate S and the ground G a substantial amount, and then the operator applies a sudden “jerk” on the tool T to overcome the retaining means 235 without dislodging the fastener F from the substrate S and the ground G.

The bit 10 of the present invention differs from prior fastener drivers in that the present bit 10 is a unitary piece that is easier to manufacture than prior, multi-piece bits. In addition to higher manufacturing costs, prior bits have increased assembly costs due to their multiple pieces. Compared to driving fasteners with a sledgehammer, the bit 10 also increases the ease and efficiency in which fasteners F are driven since less manual labor is required. This increase in efficiency decreases the overall time it takes to drive fasteners and reduces the time needed to complete a project.

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. While the specific embodiments have been illustrated and described, numerous modifications come to mind without significantly departing from the spirit of the invention, and the scope of protection is only limited by the scope of the accompanying Claims.

1. A heat treated, one-piece bit for driving an elongated fastener, the bit comprising:
a barrel having a bore extending inward from an end wall of the barrel, the bore defining an internal receiver that receives the fastener, the receiver having a length that is less than a length of the barrel whereby the barrel has a solid core with a length that exceeds the barrel length; and,
a shank extending from the barrel and having a collar, wherein the collar is externally positioned when an upper end of the shank is inserted in a driver.

2. The driver bit of claim 1, further comprising a conical transition segment positioned between the barrel and the shank.

3. The driver bit of claim 1, wherein a receiver diameter is less than a barrel diameter, wherein the barrel diameter forms an annular end wall with a thickness of at least 1.5 inches.

4. The driver bit of claim 1, wherein the ratio of the receiver diameter to the barrel diameter is at least 1:1.

5. The driver bit of claim 1, wherein the ratio of the receiver length to the barrel length is at least 1:3.

6. The driver bit of claim 1, wherein the ratio of the receiver length to the core length is at least 1:2.

7. The driver bit of claim 1, wherein the solid core has a mass of at least 10 ounces and the bit has a mass of at least 20 ounces to provide a driving force for the bit to apply to the fastener.

8. The driver bit of claim 1, wherein the barrel length is at least 2 inches, the receiver length is at least 0.75 inches, and the core length is at least 1.5 inches.

9. A unitary metal bit for driving elongated fasteners, the bit comprising:
a barrel having a first bore extending inward from an end wall of the barrel and having substantially parallel side walls to define a first receiver that receives a first-sized fastener, the barrel further having a second bore extending inward from the first receiver to define a second receiver that receives a second-sized fastener;
a shank integrally extending from the barrel and having a collar that ensures proper positioning of the bit when an upper end of the shank is inserted in a driver; and,
wherein a first receiver diameter is greater than a second receiver diameter, and wherein a notched shoulder is formed between the first and second receivers, the shoulder preventing a first-sized fastener from entering the second receiver.

10. The driver bit of claim 9, wherein the barrel has a solid core inward of the first and second receivers, the solid core having a substantial mass that provides a driving force for the bit to apply to the fasteners.

11. The driver bit of claim 9, wherein a diameter of the barrel exceeds the first and second receiver diameters and the ratio of the first receiver diameter to the barrel diameter is at least 1:1.5.

12. The driver bit of claim 9, wherein the ratio of the first receiver length to the second receiver length to the body length is at least 1:1:2.75.

13. The driver bit of claim 10, wherein the ratio of the first receiver length to the second receiver length to the core length is 1:1:2.

14. The driver bit of claim 9, wherein the first receiver and second receiver extend beyond a mid-point of the main body length.

15. The driver bit of claim 9, wherein the bit is heat treated.

16. A unitary metal bit for driving elongated fasteners, the bit comprising:
a barrel having an end wall that defines a lowermost surface of the bit, the barrel further having a cylindrical bore extending inward to define an internal receiver that receives the fastener, the receiver having means for releasably retaining the fastener to prevent unintended release of the fastener, the receiver further having a length that is less than a length of the barrel whereby the barrel has a solid core with a length that exceeds the barrel length; and,
a shank integrally extending from the barrel and having a collar that ensures proper positioning of the bit when inserted in a driver

17. The driver bit of claim 16, wherein the retaining means comprises a spring loaded ball bearing.

18. The driver bit of claim 16, wherein the retaining means is a deformable elastomeric member.

19. The driver bit of claim 18, wherein the elastomeric member is a gasket that is positioned within an annular channel of the receiver.

20. The driver bit of claim 16, wherein the retaining means is a magnet configured to overcome the effects of gravity and retain the fastener within the receiver when the bit and fastener are perpendicular to the ground.
